(19) United States
(12) Patent Application Publication
(10) Pub. No.: US 2014/0133992 A1
(43) Pub. Date: May 15, 2014

(54) CONNECTION MECHANISM FOR MOUNTING BLADES FOR A WIND TURBINE

(71) Applicant: Jeffrey Brooks, Dearborn Heights, MI (US)

(72) Inventors: Jeffrey Brooks, Dearborn Heights, MI (US); Jeffrey Bancroft, Dearborn Heights, MI (US)

(21) Appl. No.: 13/809,373

(22) PCT Filed: Jul. 13, 2011
(86) PCT No.: PCT/US11/43920

§ 371 Date: Jul. 29, 2013

Related U.S. Application Data
(60) Provisional application No. 61/363,932, filed on Jul. 13, 2010.

(51) Int. Cl. F03D 1/06

(52) U.S. Cl. CPC F03D 1/0658; F03D 1/0633
USPC 416/220 R; 416/219 R

(57) ABSTRACT

A variety of wind turbine assemblies are described herein. The wind turbine assemblies each include a plurality of blades that have a sidable connection member to secure the wind blades to a shaft member. In some configurations, recesses are provided on the shaft to secure the blades. Other configurations include separate mounting members that secure around the shaft to operatively connect the blades to the shaft.

### CROSS REFERENCE TO RELATED APPLICATION

This application claims priority to U.S. Provisional Patent Application No. 61/363,932 filed Jul. 13, 2010, the disclosures of which are incorporated by reference in its entirety.

### BACKGROUND

Turbines have been employed for many years to generate power from various forms of fluid energy. For example, wind turbines or windmills have been used for many centuries to create mechanical motion from naturally occurring wind. Turbines have also been used in rivers and streams to create energy from the movement of the water.

Turbines have traditionally suffered from low energy efficiency as a result of the relative difficulty in converting fluid energy to electrical power. For example, fluid motion typically is translated into rotational or other mechanical motion only with significant losses that decrease overall efficiency of the turbine. Turbine development has therefore often centered on increasing efficiency. For example, a wide variety of complex shapes have been developed over the years in an effort to maximize the amount of rotational force extracted from the fluid motion.

Many of these complex turbine shapes are difficult and/or expensive to manufacture and maintain. Accordingly, there is a need for an improved turbine that allows for relatively high power efficiency while offering a simplified construction that reduces assembly and maintenance costs.

### BRIEF DESCRIPTION OF THE DRAWINGS

FIG. 1 is a partial view of an exemplary turbine assembly employing an exemplary connection assembly.

FIG. 2 is a cross-sectional view of the connection assembly of FIG. 1.

FIG. 3 is an end view of a connection portion of a turbine blade for use with the connection assembly of FIG. 1.

FIG. 4 is a perspective view of the connection portion of the turbine blade of FIG. 3.

FIG. 5 is a perspective view of a front retention ring used with the connection assembly of FIG. 1.

FIG. 6 is a perspective view of a rear retention ring used with the connection assembly of FIG. 1.

FIG. 7 is a front view of an exemplary turbine assembly employing an alternative exemplary connection assembly.

FIG. 8 is a front view of a turbine blade used in the turbine assembly of FIG. 7.

FIG. 9 is a front close-up view of the connection assembly of FIG. 7.

FIG. 10 is a front view of the turbine blade of FIG. 8 with the connection assembly of FIG. 7 connected thereto.

FIG. 11 is a perspective view of another exemplary alternative turbine assembly.

FIG. 12 is a top plan view of the turbine assembly of FIG. 11.

FIG. 13 is a perspective view of another exemplary alternative turbine assembly having an alternative blade configuration.

FIG. 14 is a top plan view of the turbine assembly of FIG. 13.

FIG. 15 is a top plan view of a turbine assembly employing an alternative blade configuration.

FIG. 16 is an enlarged view of an alternative configuration of a connection assembly.

FIG. 17 is an end view of an exemplary turbine shaft of the connection assembly of FIG. 16.

FIGS. 18A and 18B are isometric views of an exemplary blade having a sail portion and a rib structure for retaining the blades to a shaft.

FIG. 19 is an angled front view of an exemplary turbine blade assembly employing an alternative blade configuration (shown on a shop mount).

FIG. 20 is an angled side view of an exemplary turbine blade assembly employing an alternative blade configuration (shown on a shop mount).

FIG. 21 is an angled top view of an exemplary turbine blade assembly employing an alternative blade configuration (shown on a shop mount).

FIG. 22 is a partial view of an exemplary turbine blade assembly employing an alternative blade configuration (shown on a shop mount).

### DETAILED DESCRIPTION

Various exemplary illustrations of a turbine, e.g., for use in wind turbines or windmills, a turbine shaft assembly, and methods of making the same are disclosed herein. An exemplary wind turbine assembly may include a shaft that defines a plurality of axially extending recesses, and a corresponding plurality of blades engaged with the shaft for rotation therewith. The blades may be engaged with the shaft via a rib structure extending generally axially along the shaft. The rib structure may be received in a corresponding cavity of the shaft, thereby allowing selective installation and removal of each blade by sliding the blade axially so the rib is slid out of the shaft cavity. The blades may also include a sail structure to which the rib structure is generally fixed. The sail structure may be configured to apply rotational force to the shaft, e.g., due to fluid movement about the sail structure. The wind turbine assembly may also include a shaft collar that selectively secures the blades to the shaft.

Turning now to the Figures, exemplary illustrations of a turbine assembly and connection assemblies for same are illustrated. The various exemplary embodiments will now be described.

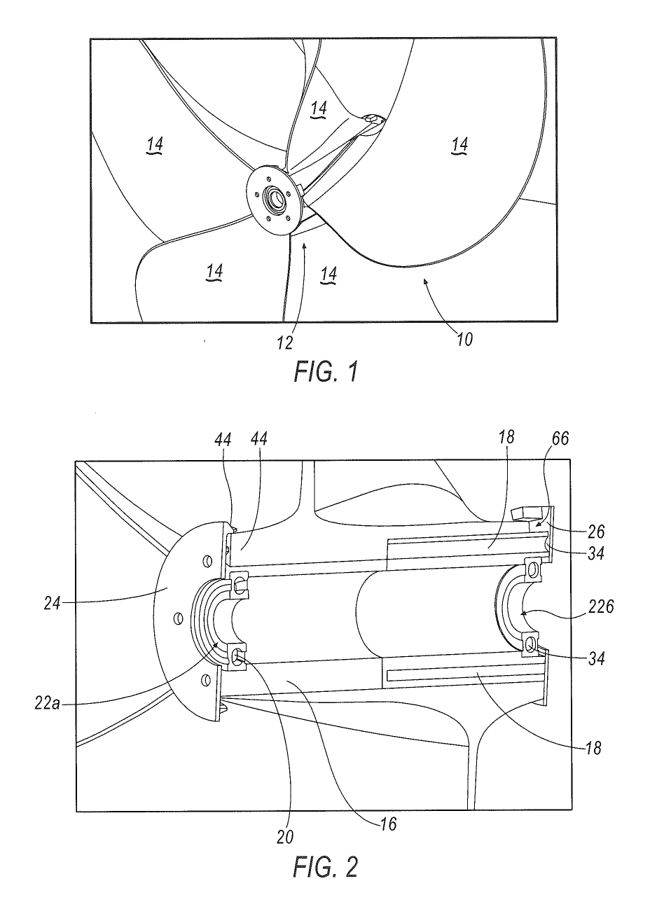

FIG. 1 illustrates an exemplary turbine assembly 10 that employs an exemplary connection assembly 12. Turbine assembly 10 comprises a plurality of turbine blades 14 that are operatively connected to connection assembly 12. While turbine assembly 10 is shown as having five turbine blades 14, it is understood that the present disclosure is not limited to a specific number of turbine blades. Turbine blades 14 generally convert fluid movement, e.g., in an axial direction with respect to connection assembly 12, to rotational motion. Turbine blades 14 may be formed of any material that is convenient. In one exemplary configuration, turbine blades 14 may be formed of an injection molded nylon material.

Each turbine blade 14 defines a sail portion that is configured to interact with wind. In some exemplary illustrations, the sail portions of each turbine blade 14 may be shaped to create rotational motion of the shaft in response to fluid movement generally perpendicular to the connection assembly 12. In one exemplary configuration, the sail portions may define a generally helicoidal shape. The helicoidal shaped sails may define a cross-sectional span configured to turn the connection assembly 12 in response to fluid, e.g., wind, moving either generally parallel or generally perpendicular to the connection assembly 12. Any other shape or configuration of the sail portions may be employed.

As will be described in greater detail below in connection with alternative embodiments, the surfaces of the sail portions of the turbine blades 14 may be configured to be generally smooth. Alternatively, the sail portions of turbine blades 14 may include one or more radial webs to generally stiffen the structure of the sail portions, thereby permitting minimal overall weight of the turbine blades 14 while also providing adequate stiffness of the turbine blades 14, thereby maximizing transfer of fluid energy to the connection assembly 12.

Referring to FIG. 2, a cross-sectional view of connection assembly 12 may be seen in further detail. More specifically, connection assembly 12 comprises a hollow mounting member 16 having connection channels 18 formed therein, and bearings 20 disposed on internal flange members 22a, 22b disposed on either end of mounting member 16. Connection assembly 12 further includes front and rear retention rings 24, 26 that are mounted on either end of mounting member 16. Mounting member 16 is further configured with a hollow opening therethrough for receiving a shaft member (not shown).

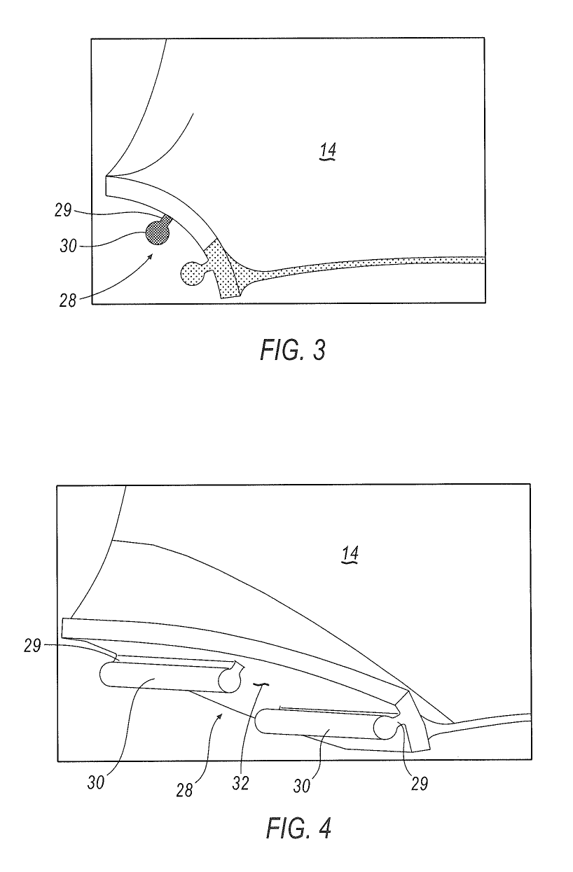

Referring to FIGS. 3 and 4, connection portions 28 of turbine blade 14. Connection portions 28 include at least one mounting protrusion 30 that extends from a surface 32 of connection portion 28 by a connecting rod 29. While FIG. 3 illustrates that the mounting protrusions 30 have a generally circular cross-sectional shape, it is understood that the present disclosure is not limited to this specific configuration. Mounting protrusion 30 is generally sized and shaped to correspond to the geometry of connection channels 18. More specifically, mounting protrusions 30 are configured to slide into an open end 34 of a mating channel 18 to positively retain turbine blade 14 on mounting member 16. Once all of the turbine blades 14 are secured to mounting member 16 in this manner, rear retention ring 26 is secured to mounting member 16, as will be explained below in further detail.

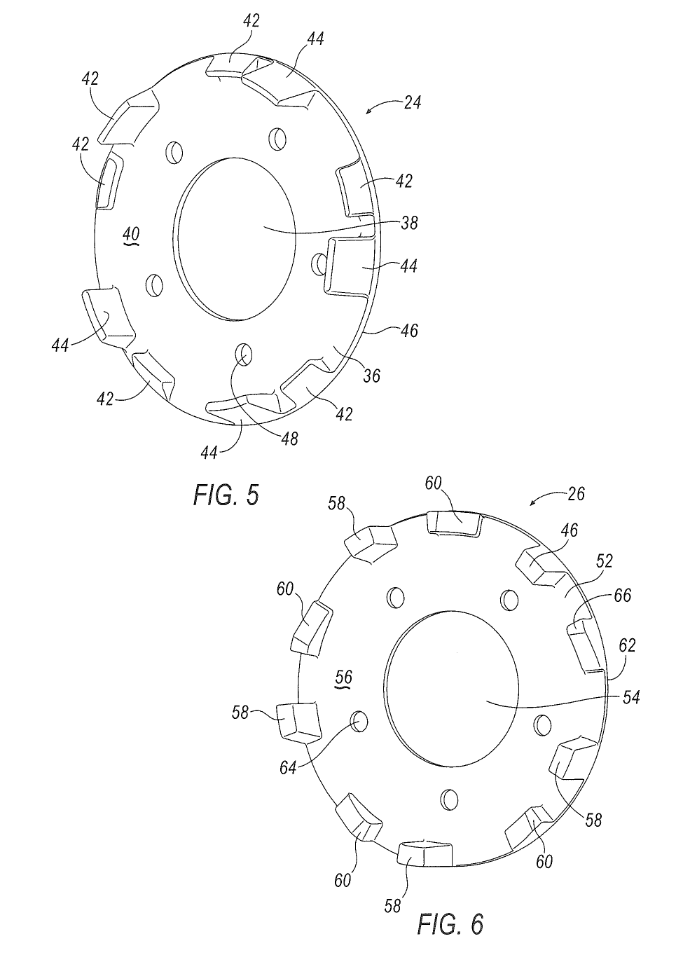

Referring to FIGS. 5 and 6, front and rear retention members 24, 26 will now be explained. In the exemplary embodiment, front retention member 24 is configured with a generally circular shaped body member 36 that includes an opening 38 therein configured to permit a shaft to extend therethrough. Body member 36 is sized to be larger than mount member 16. Disposed on an inside surface 40 of body member 36 are a plurality of first and second protrusions 42, 44. First protrusions 42 are arranged adjacent to second protrusions 44 and both are positioned along a peripheral edge 46 of body member 36. A plurality of mounting openings 48 are also arranged in body member 36.

As best seen in FIGS. 1 and 2, once the turbine blades 14 have been installed in mounting member 16, front retention member 24 is positioned on a forward end of mounting member 16. Each first and protrusion 42 is configured to connect to a forward edge 50 of a turbine blade 14. More specifically, first and second protrusions 42 are configured to overlay and grip forward end 50 of turbine blade 14. Fasteners are inserted through mounting openings 48 to fixedly secure front retention member 24 to mounting member 16.

Each rear retention member 26 is configured with a generally circular shaped body member 52 that includes an opening 54 therein configured to permit a shaft to extend therethrough. Body member 52 is also sized to be larger than mount member 16. Disposed on an inside surface 56 of body member 52 are a plurality of first and second protrusions 58, 60. First and second protrusions 58, 60 are arranged in an alternating manner and both are positioned along a peripheral edge 62 of body member 52. First protrusion member is configured with a generally rectangular shape, while second protrusion member is configured with an angled shape to accommodate the curved nature of the turbine blades 14. A plurality of mounting openings 64 are also arranged in body member 52.

As best seen in FIGS. 1 and 2, once the turbine blades 14 have been installed in mounting member 16, rear retention member 26 is positioned on a rear end of mounting member 16. Each first and second protrusion 58 and 60 is configured to connect to a rear edge 66 of a turbine blade 14. More specifically, first and second protrusions 58 and 60 are configured to overlay and grip rear edge 66 of turbine blade 14. Fasteners are inserted through mounting openings 64 to fixedly secure rear retention member 26 to mounting member 16, thereby closing open end 34 of mounting channels 18 and effectively locking turbine blades 14 to mounting member 16.

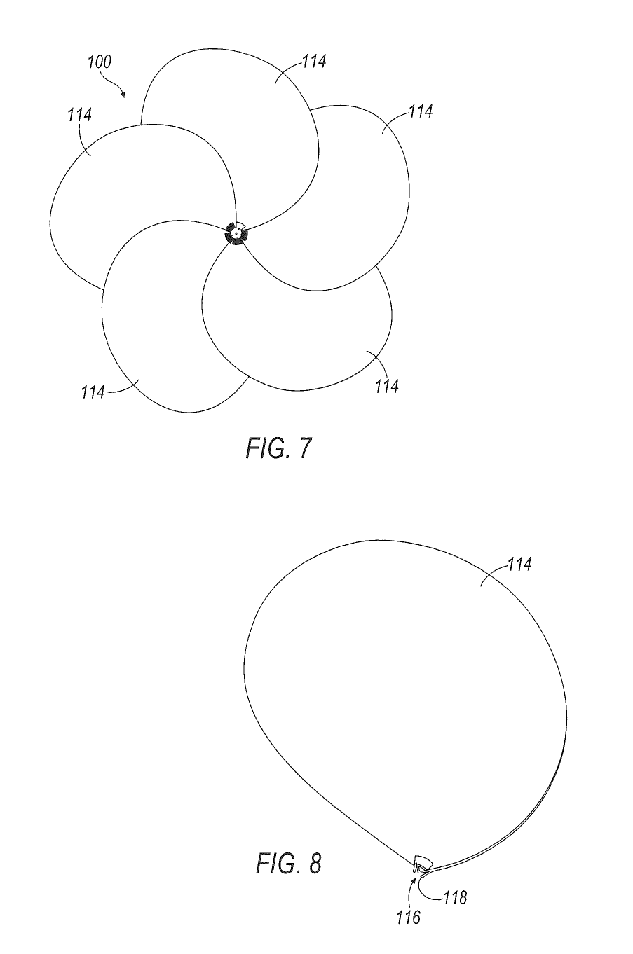

Turning now to FIG. 7, an alternative embodiment of an exemplary turbine assembly 100 employing an alternative exemplary connection assembly 112 is shown. Similar to the embodiment discussed in connection with FIG. 1, turbine assembly 100 comprises a plurality of turbine blades 114 that are operatively connected to connection assembly 112. While turbine assembly 100 is shown as having five turbine blades 114, it is understood that the present disclosure is not limited to a specific number of turbine blades. Turbine blades 114 generally convert fluid movement, e.g., in an axial direction with respect to connection assembly 112, to rotational motion. Turbine blades 114 may be formed of any material that is convenient. In one exemplary configuration, turbine blades 114 may be formed of an injection molded nylon material.

As discussed above, each turbine blade 114 defines a sail portion that is configured to interact with wind. In some exemplary illustrations, the sail portions of each turbine blade 114 may be shaped to create rotational motion of the shaft in response to fluid movement generally perpendicular to the connection assembly 112. In one exemplary configuration, the sail portions may define a generally helicoidal shape. The helicoidal shaped sails may define a cross-sectional span configured to turn the connection assembly 112 in response to fluid, e.g., wind, moving either generally parallel or generally perpendicular to the connection assembly 112. Any other shape or configuration of the sail portions may be employed.

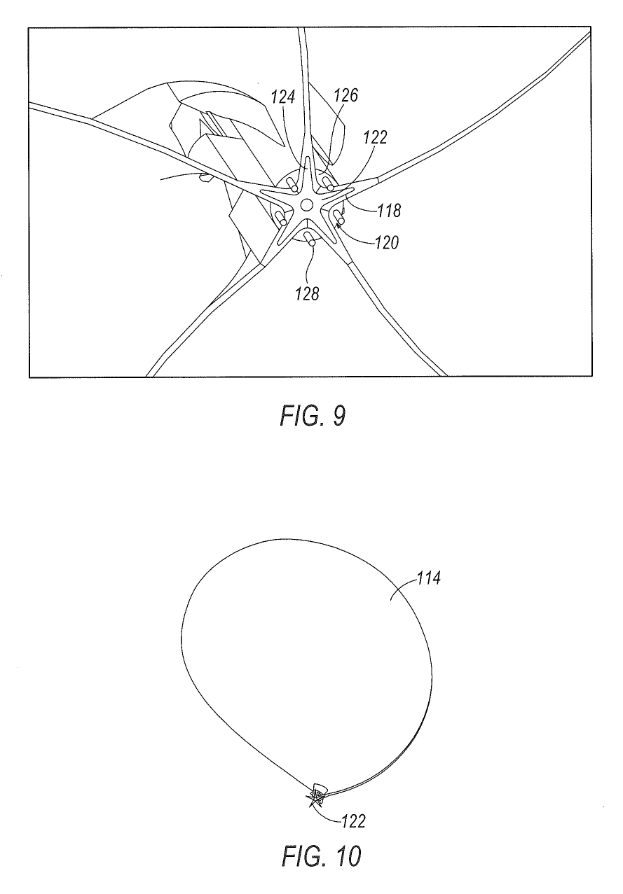

Referring to FIG. 8, a front view of a turbine blade 114 that may be used in the turbine assembly 100 of FIG. 7 will now be described. Each turbine blade 114 includes a connection member 116 that defines a nesting chamber 118 therein that receives a portion of a shaft 120 (best seen in FIG. 9). In the exemplary embodiment shown in FIG. 8, nesting chamber 118 includes at least one channel that generally has a triangular cross-sections.

As shown in FIGS. 9-10, a portion of shaft 120 is disposed within the nesting chamber 118 of each turbine blade 114. More specifically, in the exemplary embodiment depicted, shaft 120 is configured to have a star-shaped body member 122 defined by triangular shaped extensions 124. Clamp members 126 (best seen in FIG. 9), are disposed between each channel of the nesting chamber 118 to provide strength to the connection assembly 116. Connection pins (or other suitable fasteners) 128 extend outwardly from an end face of clamp members 126. An end cap 130 (seen best in FIG. 7), is secured to the end face of shaft 120. More specifically, connection pins 128 are received within mounting openings formed through end cap 130.

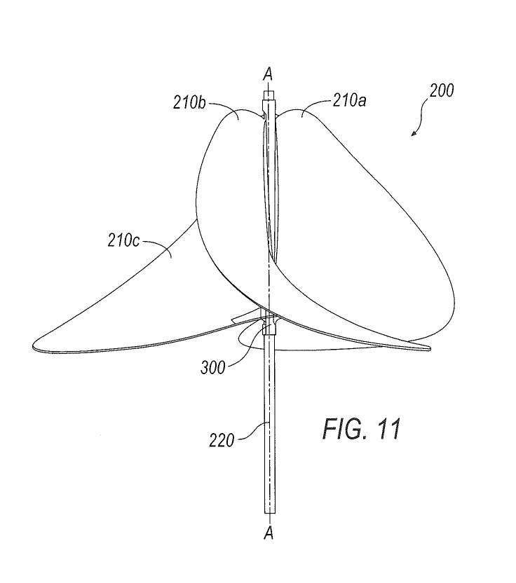

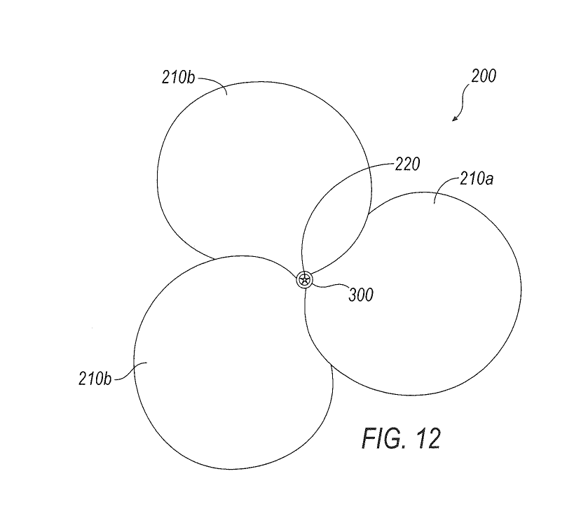

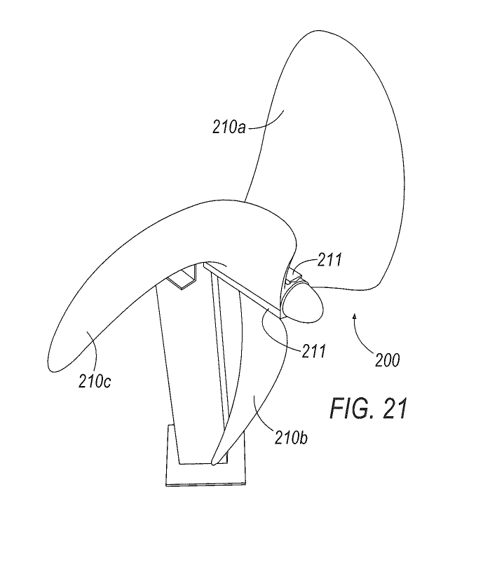

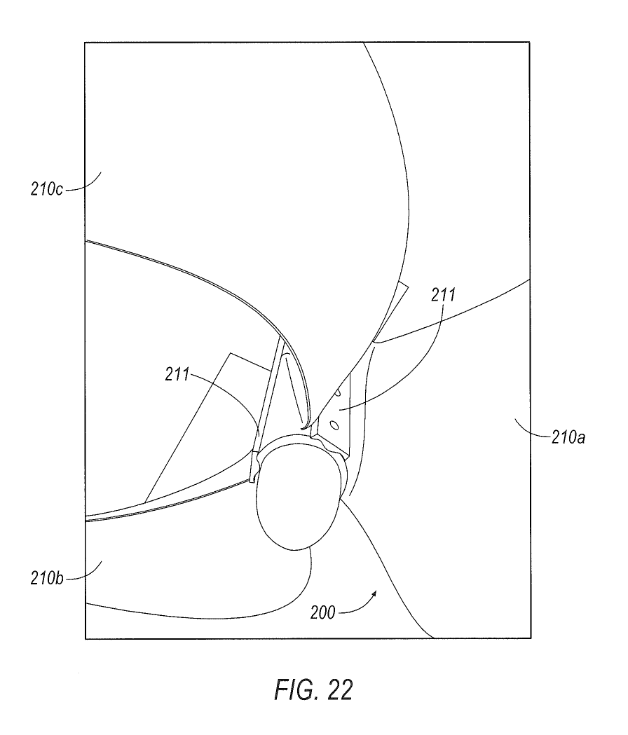

Turning now to FIGS. 11-12 and 19-22, exemplary illustrations of an alternative turbine and shaft assembly 200 will now be described in further detail. More specifically, FIG. 11 illustrates an example of a turbine assembly 200 that includes a plurality of fins or blades 210a, 210b, 210c (collectively, 210) that are secured to a shaft 220 for rotation with the shaft 220. The shaft 220 may be formed of any material that is convenient, e.g., a steel material, and generally defines an axis A-A. A shaft collar 300 may be provided to secure the blades 210 to the shaft 220. For example, the shaft collar 300 may prevent movement of the blades 210 axially with respect to the shaft 220.

The blades 210 may generally convert fluid movement, e.g., in an axial direction with respect to the shaft 220, to rotational motion of the shaft 220. While three blades 210 are illustrated, any number of blades 210 may be employed that is convenient. The blades 210 may be formed of any material that is convenient, e.g., an injection molded nylon material.

Each blade 210 may include a sail portion that is fixed to a shaft engaging portion, including a rib structure. In some exemplary illustrations, the sail portion may be shaped to create rotational motion of the shaft 220 in response to fluid movement generally perpendicular to the shaft 220. For example, as best seen in FIGS. 11-12 and 19-22, the sail portions may define a generally helicoidal shape. The helicoidal shaped sail portions may define a cross-sectional span configured to turn the shaft 220 in response to fluid, e.g., wind, moving either generally parallel or generally perpendicular to the shaft 220. Any other shape or configuration of the sail portions may be employed.

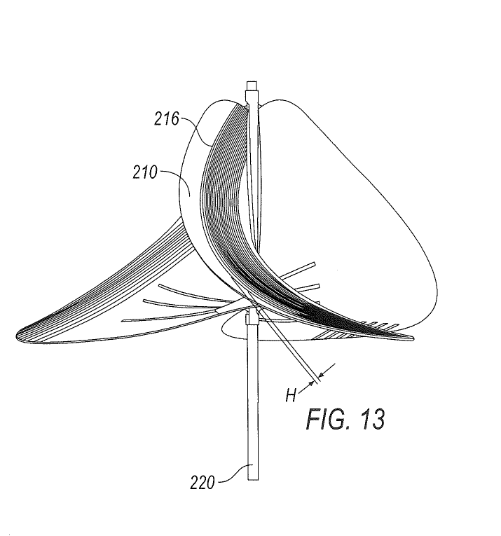

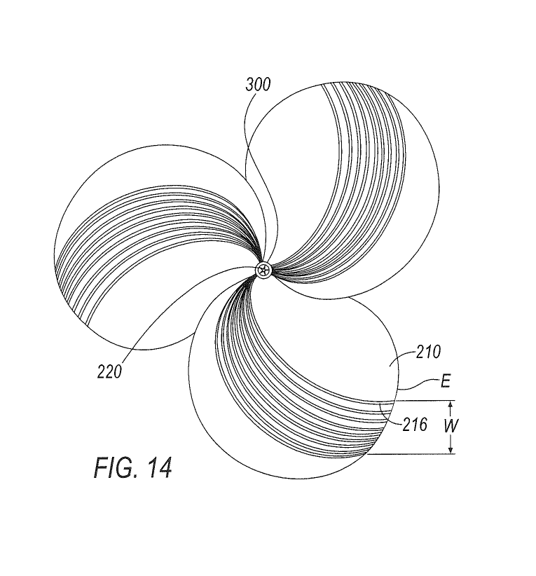

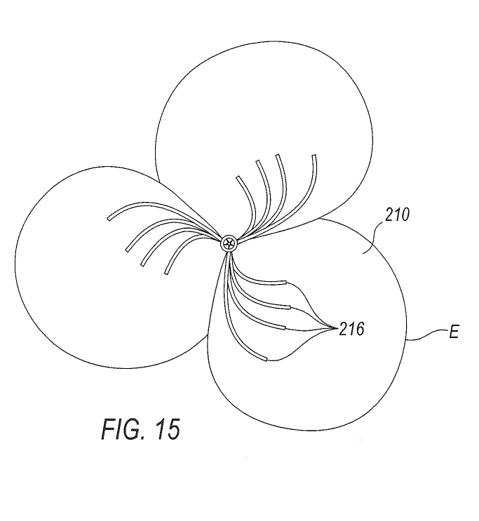

The surfaces of the sail portions may be generally smooth, for example as seen in FIGS. 11-12. Alternatively, as best seen in FIGS. 13-14, the sail portions of blades 210 may include one or more radial webs 216. Radial webs 216 may be provided to generally stiffen the structure of the blades 210, thereby permitting minimal overall weight of the blades 210 while also providing adequate stiffness. Such a construction maximizes the transfer of fluid energy to the shaft 220. For example, the radial webs 216 may define an extension height H, as best seen in FIG. 13, away from the surface of the sails 102. As best seen in FIGS. 13-14, the radial webs 216 may extend along the surface of the blades 210 from a radially inner position adjacent the shaft 220, with the plurality of webs 216 defining a widening radial width W as the radial webs 216 extend radially outwardly and away from the shaft 220. The radial webs 216 may extend along an entire length of the blades 210, e.g., from a radially inner location adjacent the shaft 220 all the way to an outer edge E of the blades 210, for example as shown in FIG. 14. Alternatively, the webs 216 may extend only a portion of the length of the blades 210, such that the webs 216 end within an outer periphery of the blades 210, for example as shown in FIG. 15.

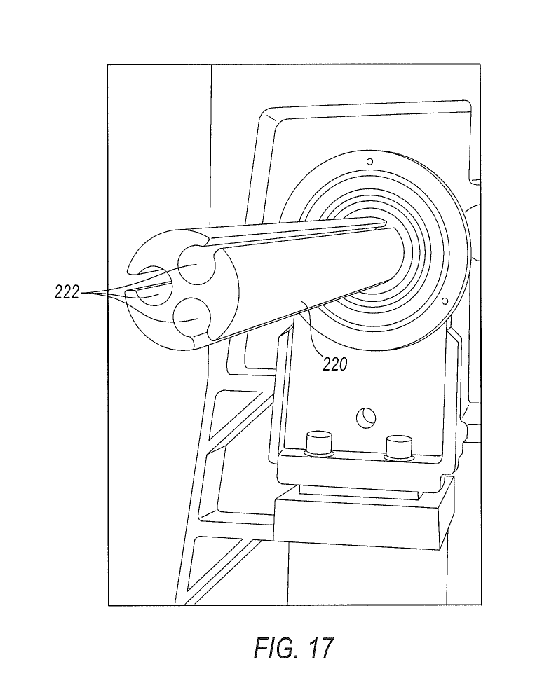

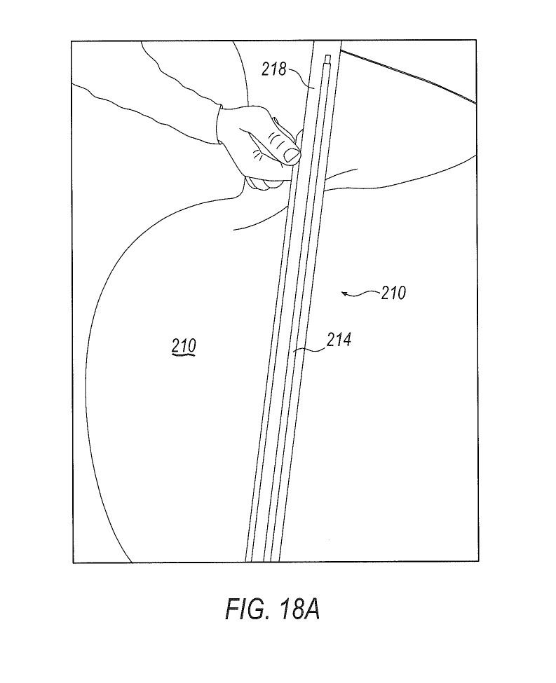

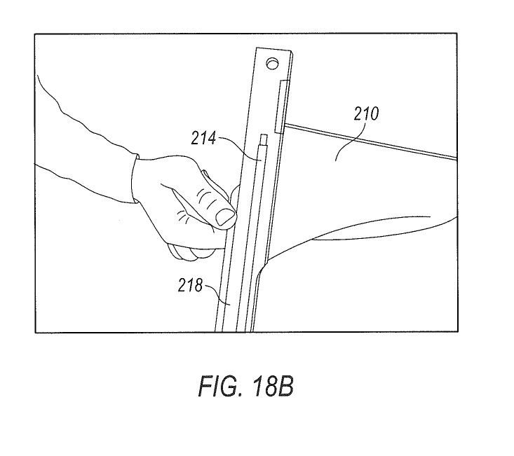

As mentioned above, the blades 210 may be generally fixed to a rib structure 214 that is configured to be selectively secured to the shaft 220. For example, as best seen in FIGS. 18A-18B, the rib structure 214 may generally be inserted into a corresponding cavity or recess 222 disposed longitudinally along the shaft 220. The rib structure 214 and recess 222 may define mating cross-sections such that the rib structure 214 may be slid axially with respect to the shaft 220 into the recess 222. As best seen in FIGS. 17, the cross-section of rib structure 214 may be generally circular and mating corresponds to the size and shape of recess 222. However, it is understood that other cross-sections may be employed without departing from the disclosure.

Referring now to FIGS. 18A-18B, the blades 210 may also include a radial stabilizer 218 that engages the shaft 220 to stabilize the blades 210 in a radial direction with respect to the shaft 220. More specifically, radial stabilizer 218 may extend around at least a portion of a circumference of the shaft 220 and engage outer surfaces of the shaft 220 to substantially prevent the blades 210 from rotating about the shaft 200. Accordingly, energy transfer from the blade 210 due to fluid movement, e.g., wind, is thereby maximized. One or more shaft webs 230 may be provided to increase the collective stiffness of the blade 210 and stabilizer 218, thereby further increasing energy transfer efficiency of the blades 210.

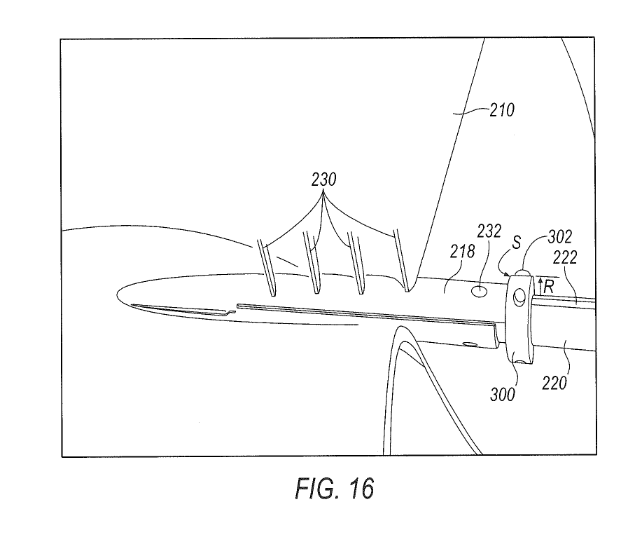

As best seen in FIGS. 16-17, shaft collar 300 may be provided to generally fix the blades 210 axially with respect to the shaft 220. More specifically, the shaft collar 300 may define a radial extension R (see FIG. 16) in a direction generally perpendicular to the shaft 220. The radial extension R provides an abutment surface to prevent axial movement of the blades 210. Further, one or more mechanical fasteners (not shown) may be employed to affix the blades 210 to the collar 300. The collar 300 may define a gap or split S that allows the collar 300 to be slid along the shaft 200. A mechanical fastener 302, e.g., a bolt, may be used to tighten the collar 300, thereby reducing a gap defined by the split S and limiting or preventing entirely any axial movement of the collar 300 with respect to the shaft 220. Further, the abutment and/or positive engagement of the blades 210 to the collar 300 may in turn prevent movement of the blades 210 with respect to the shaft 220, at least in an axial direction with respect to the shaft 220. The shaft collar 300 may be formed of any material that is convenient, e.g., a steel material.

Alternatively or in addition to the shaft collar 300, the blades 210 may be secured directly to the shaft 220. For example, as best seen in FIG. 16, the blades 210 may have an aperture 232 that is configured to receive a mechanical fastener (not shown), e.g., a threaded bolt, that extends through the aperture 232 and secured to a corresponding threaded aperture in the shaft 220. Such an arrangement may not only affix the blades 210 axially with respect to the shaft 220, but may also further inhibit rotation of the blade 210 and/or stabilizer 218 with respect to the shaft 220 as well.

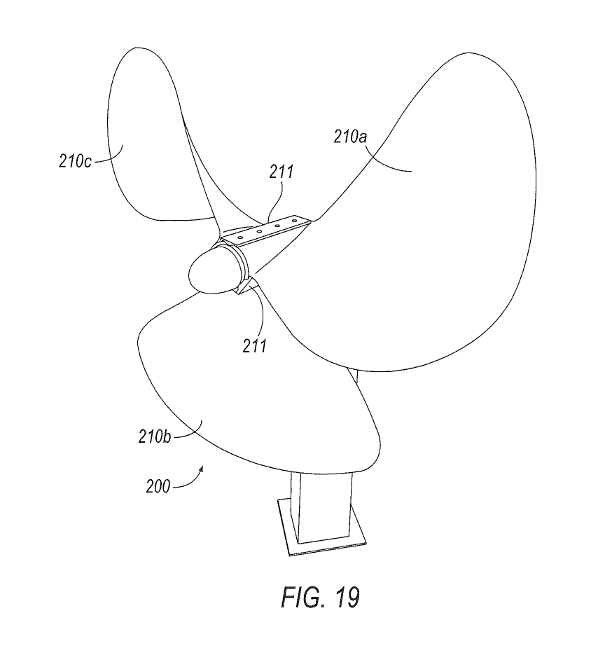

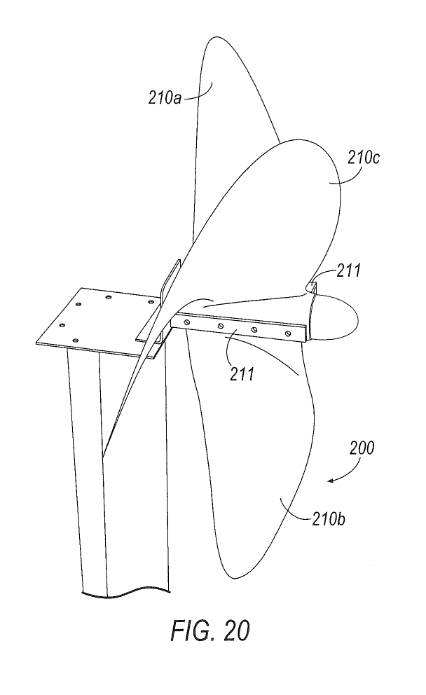

Alternatively or in addition to one or more other mounting mechanisms, blades 210 are configured with a keyway running the length of the blade/shaft connection, and the blades 210 are fastened to the shaft 220 with one or more blocks 211 made of aluminum or other material of suitable weight and strength (as nonlimiting examples, see FIGS. 19-20)

All of the exemplary illustrations provided herein of various turbine assemblies 10, 100, 200 allow for a generally modular assembly where the blades may be selectively removed from the shaft, e.g., for service or replacement of the blades.

What is claimed is:

1. A wind turbine assembly, comprising:
a turbine shaft, the shaft defining a plurality of axially extending recesses; and
a plurality of blades engaged with the shaft for rotation therewith, each of the blades including a connecting portion that is slidably engaged with a corresponding one of the axially extending recesses.

2. The wind turbine assembly of claim 1, wherein the blades each define a helical shape.

3. The wind turbine assembly of claim 1, wherein the blades each define a helicoidal shape.

4. The wind turbine assembly of claim 1 wherein the recesses are configured with a main body portion and a connecting channel therein, wherein the main body portion is larger than the connecting channel.

5. The wind turbine assembly of claim 4, wherein the main body portion of the recesses are configured with a generally circular cross-section.

6. The wind turbine assembly of claim 1, further comprising a stabilizer that operatively engages the shaft.

7. The wind turbine assembly of claim 1, further comprising a radial web extending at least partially along the surface of each blade.

8. The wind turbine assembly of claim 7, wherein the radial web extends from a radially inner position that is adjacent to the shaft, when the blade is in an installed position, to a peripheral edge of the blade.

9. The wind turbine assembly of claim 8, further comprising a plurality of radial webs defining a widening radial width between adjacent radial webs as each radial web extends radially outwardly and away from the shaft.

10. The wind turbine assembly of claim 1, further comprising a collar selectively secured to the shaft, the collar configured to slide axially with respect to the shaft.

11. The wind turbine shaft assembly of claim 10, wherein the collar defines a radial extension configured to prevent axial motion of the blades with respect to the shaft.

12. A wind turbine assembly, comprising:
a connecting assembly that further comprises front and rear retention members and a mounting member, wherein the mounting member includes connecting channels; and
a plurality of blades, wherein each blade further comprises a connection portion having a mounting protrusion thereon, wherein each mounting protrusion is configured to engage with one of the connecting channels of the shaft such that the blade is connected to the shaft for rotation therewith, and wherein the connection portion of each of the blades is slidably engaged with a corresponding connecting channel of the mounting member.

13. The wind turbine assembly of claim 12, wherein the front and rear retention members further include first and second protrusions extending from an inside surface of a body portion thereof.

14. The wind turbine assembly of claim 12, wherein the mounting protrusions of connection portion extends downwardly from an outwardly extending surface of the connection portion.

15. The wind turbine assembly of claim 12, further comprising a radial web extending at least partially along the surface of each blade.

16. The wind turbine assembly of claim 15, wherein the radial web extends from a radially inner position that is adjacent to the shaft, when the blade is in an installed position, to a peripheral edge of the blade.

17. The wind turbine assembly of claim 16, further comprising a plurality of radial webs defining a widening radial width between adjacent radial webs as each radial web extends radially outwardly and away from the shaft.

18. A wind turbine assembly, comprising:
a turbine shaft, the shaft defining a plurality of outwardly extending members;
a plurality of blades, each blade configured with a nesting connection configured to receive one or more of the outwardly extending members; and
a clamping member positioned between each outwardly extending members so as to impart an inwardly extending radial force toward the shaft.

19. The wind turbine assembly of claim 18, wherein the turbine shaft is star-shaped.

20. The wind turbine assembly of claim 18, wherein the nesting connection is defined by at least one longitudinally extending channel that is generally sized and shaped to correspond to the outwardly extending members of the shaft.
